(19) United States
(12) Patent Application Publication
(10) Pub. No.: US 2012/0069419 A1
(43) Pub. Date: Mar. 22, 2012

(54) ELECTROCHROMIC FORMULATION, METHOD FOR THE PRODUCTION THEREOF, AND ORGANIC ELECTROCHROMIC COMPONENT

(76) Inventors: Andreas Kanitz, Hochstadt (DE); Marek Maleika, Furth (DE); Wolfgang Roth, Uttenreuth (DE)

(21) Appl. No.: 13/375,034

(22) PCT Filed: May 6, 2010
(86) PCT No.: PCT/EP10/56176

§ 371 Date: Nov. 29, 2011

(30) Foreign Application Priority Data
May 29, 2009 (DE) 10 2009 023 303.2

(51) Int. Cl. G02F 1/15; C09K 9/02

(52) U.S. Cl. 359/265; 252/583

(57) ABSTRACT

Formulations can be used in organically based electrochromic components, such as for the production of state indicators, the activated state of which is maintained for as long as possible without an electric current. Organically based electrochromic formulations contain one or more optionally cathodically (coloring) activatable electrochromic coloring systems, as well as an anodically activatable antagonist formed of an amine which dimerizes to a hydrazinium salt by releasing an electron. Titanium dioxide is introduced as an image background (maximum opacity), and additionally a dispersant is introduced which can be crosslinked or partly crosslinked.

### CROSS REFERENCE TO RELATED APPLICATIONS

This application is based on and hereby claims priority to International Application No. PCT/EP2010/056176 filed on May 6, 2010 and German Application No. 10 2009 023 303.2 filed on May 29, 2009, the contents of which are hereby incorporated by reference.

### BACKGROUND

The invention relates to formulations and the use thereof in organically based electrochromic components.

Electrochromic displays based on organic materials normally comprise an active electrochromic layer which in the case of a display is sandwiched between electrodes arranged vertically with respect to each other. Important constituents of the active layer are a redox system and an electrochromic dye. The concentration ratio of the redox partners relative to one another in the material is shifted through the application of a voltage. During this reaction protons and/or ions are liberated or bound in the material, which has an effect on the pH value. When a voltage is applied to the material, the shift in the equilibrium of the redox partners at the two electrodes runs in the opposite direction. This leads to an increase in the pH value at one of the electrodes for example, while the value decreases at the counter electrode. The change in pH value is then converted via a pH dye into a change in the color of the material and the application of the voltage is made visible.

It is known from WO 02/075441 A2 and WO 02/075442 A1 that a paste-like formulation which represents the electrochromic system is located between the electrodes. The composition of the electrochromic system includes as essential constituents a polymer as a solid electrolyte, a conducting salt, a redox system, TiO₂ as white pigment, a solvent and a dye. The latter is usually a pH indicator.

A further principle for implementing electrochromic displays relates to bringing about the color change not by changing the pH value in the display, but by utilizing the redox processes taking place anyway to generate high-contrast color changes by creating reductive and/or oxidative states in suitable materials. In this context it is principally the so-called viologens and polythiophenes that have become known as material classes. Examples hereof in the literature can be found in M. O. M. Edwards, Appl. Phys. Lett. 2005, 86(7) and Helmut W. Heuer, Rolf Wehrmann, Stephan Kirchmeyer, Adv. Funct. Mater. 2002, 89.

In general it is aimed to produce electrochromically active formulations which change their color state quickly when a voltage is applied and also return quickly to the initial state again when voltage is removed. This behavior is desirable for displays. For state indicators, e.g. on/off, it is advantageous to have formulations which, after reaching the switched state, remain for as long a time as possible or permanently in the state without further voltage being applied. Although such electrochromic systems are well-known, e.g. electrochromic mirrors or anchor viologens on titanium dioxide crystals a) L. Walder, M. Möller, patent EP 1 271 227, 2003, b) M. Möller, S. Asaftei, D. Corr, M. Ryan, L. Walder, Adv. Mater. 2004, 16, 1558, these systems necessitate a huge technological investment, with the consequence that simple displays/indicators become too expensive.

Irreversibly switching electrochromic components, known from DE 10 2006 015 056, and bistable electrochromic components, known from DE 10 2006 045 307, can be produced with little effort and investment from the electrochromic systems already filed by the applicant for the granting of a patent.

### SUMMARY

One potential object is to develop electrochromically active bistable formulations which can be processed using simple technological processes to produce one-time switchable displays.

The inventors propose a bistably switchable electrochromic formulation comprising one or more cathodically switchable electrochromes as well as at least one anodically switchable antagonist having the following structure I

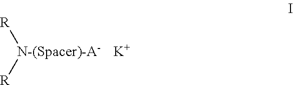

where “Spacer” stands for an alkene grouping with up to 18 C atoms, preferably in the range from 2 to 6 C atoms and in particular with 4 C atoms,
R is selected from the group comprising alkyl and/or hydroxyalkyl residues with 2 to 10 carbon atoms, phenyl, p-tolyl, m-tolyl and/or mesityl residues, residues suitable for forming dimers and polymers, i.e. residues which for their part still have a free valence, as well as residues suitable for crosslinking the residues R, such that the two residues R bind in a bidentate manner to the nitrogen, in particular -alkene- with up to 10 carbon atoms in the chain, preferably with 2 to 6 C atoms,
A⁻ is an anion, for example —SO₃⁻, —COO⁻, —O⁻,
and
K⁺ is a cation, for example an alkali ion, an ammonium ion or an arbitrarily substituted alkyl ammonium ion,
as well as
a white pigment and a dispersing agent which can be at least partly crosslinked.

The organically based electrochromic formulation may be used for the production of state indicators, the activated or switched state of which is maintained for as long as possible without an electric current. The organically based electrochromic formulations are characterized in respect of the display by a high degree of bistability and depending on implementation can also remain irreversibly in the switched color state after a one-time activation period.

Always required in addition for charge equalization in an electrochromic system when using a cathodically switchable, i.e. reducible, coloring component is a compound which can be oxidized, the so-called anodic antagonist in the formulation.

It has been found that the amines of the structure I can be used as bistable antagonists (oxidation materials) which, during the oxidation to radical cations, instantly dimerize further to hydrazinium salts. These are now no longer able to take back the released electron that was required for the coloring reduction of the cathodic side, because the dimer form is so stable. For this reason the color of the display/indicator, once it has been activated, is maintained without electric current being applied. As a result of anodic oxidation there is formed at the nitrogen atom of the structure I an amine radical which then instantly and irreversibly dimerizes to the hydrazinium.

The oxidation takes place for example at a switching voltage of between 0.7 and 3.7 V, in particular of between 1.0 and 3V, dependent on the oxidation potential of the amine.

Cathodically switchable electrochromic color systems are all systems which can pick up electrons at the cathode, e.g. 4,4′-bipyridinium and all substituted forms thereof. Examples of cathodic electrochromes are in particular all compounds which, by capturing an electron at the cathode, transition into a radical-ionic or radical species while undergoing a change in the color impression:

Two typical representatives of such compounds shall be cited, each with one example; all N,N′-disubstituted saline derivatives of bipyridines, such as poly-dodecylene-4,4′-bipyridinium-dibromide and all N,N′-disubstituted saline derivatives of the 2,5-di(pyridine-4-yl)pyrimidine, such as N,N′-diheptyl-2,5-pyrimidinylene-di-4-pyridinium-dibromide.

A glycol, for example, preferably diethylene glycol, is used as a dispersing agent which can be at least partly crosslinked.

Bistability is understood to mean the phenomenon whereby the displays or indicators which are present in a specific color or having a white appearance transition into the switched state with a different color or having a black appearance as a result of a direct-current pulse being applied, in which state they remain unchanged after current is no longer applied. Displays of this type can display specific measurement parameters for example for an indefinite length of time without further energy requirements.

The white pigment serves as an image background (maximum opacity). Titanium dioxide, for example, is preferably used for this purpose. Other white pigments can, of course, also be used provided that they do not negatively affect the ability to process the formulation or its stability.

### DETAILED DESCRIPTION OF THE PREFERRED EMBODIMENT

Reference will now be made in detail to the preferred embodiments, examples of which are illustrated below.

### Exemplary Embodiments

### Production of the Oxidation Material:

1.1 1-(di-p-tolyl-amino)-butane-4-sulfonate lithium salt

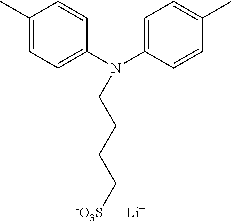

mp: 300-305° C. decomp.

Di-p-tolylamine is dissolved with butane sultone in acetonitrile in the stoichiometric ratio and converted under reflux for 6h. The formed betaine addition product is completely precipitated with ether and extracted by suction, then dissolved in methanol and neutralized with LDA. The formed lithium-1-(di-p-tolyl-amino)-butane-4-sulfonate is again precipitated using ether and extracted by suction. Yield virtually quantitative.

1.2 1-(polyethylene-amino)-butane-4-sulfonate sodium salt

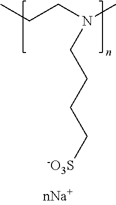

### mp: 193-210° C.

Polyethylenimine (n: approx. 300) is dissolved with butane sultone in acetonitrile and ethanol 1/1 in the stoichiometric ratio and converted under reflux for 6h.

The formed polymer betaine addition product is completely precipitated with ether and extracted by suction, then dissolved in water and neutralized with NaOH. The formed 1-(polyethylene-amino)-butane-4-sulfonate sodium salt is concentrated to dryness on the rotary evaporator, then dissolved in a little hot methanol and precipitated with ether and extracted by suction. Yield virtually quantitative.

1.3 1-(diethanol-amino)-butane-4-sulfonate sodium salt

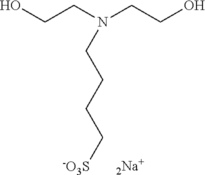

### mp: 135-140° C.

Diethanolamine is dissolved with butane sultone in acetonitrile in the stoichiometric ratio and converted under reflux for 6h. The formed betaine addition product is completely precipitated with ether and extracted by suction, then dissolved in water and neutralized with NaOH. The formed sodium- is concentrated to dryness on the rotary evaporator, then dissolved in a little hot methanol and precipitated with ether and extracted by suction. Yield virtually quantitative.

1.4 Piperazine-N,n′-dibutane-sulfonate sodium salt

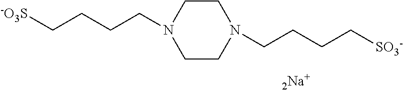

### mp: 270-275° C.

Piperazine is dissolved with butane sultone in acetonitrile in the stoichiometric ratio and converted under reflux for 6h. The formed betaine addition product is completely precipitated with ether and extracted by suction, then dissolved in water and neutralized with NaOH. The formed piperazine-N,n′-dibutane-sulfonate sodium salt is concentrated to dryness on the rotary evaporator, then dissolved in a little hot methanol and precipitated with ether and extracted by suction. Yield virtually quantitative.

2 Production of an electrochromically active formulation and of an electrochromic cell for an organic electrochromic component therefrom.

2.1 3 g titanium dioxide are dispersed with 0.3 g poly(dodecylene-4,4′-bipyridinium-dibromide) and 0.21 g 1-(di-p-tolyl-amino)-butane-4-sulfonate lithium salt in 2 g diethylene glycol using a speed mixer. A white paste is obtained. This is applied using doctor blade technology onto a first ITO-coated PET film. A second ITO-coated PET film acting as a counter electrode is adhesively bonded to the first electrode as a backing electrode by a double-sided adhesive tape frame. When a direct-current voltage of 3V is applied for one minute, a deep blue color impression is created. For example, the following laboratory values (the initial values in parentheses) are measured after 12 days (GretagMcBeth Eye One): L=10(10), a=2.5 (1), b=5 (5).

2.2. 6 g titanium dioxide are dispersed with 0.6 g poly(dodecylene-4,4′-bipyridinium-dibromide) and 0.25 g 1-(polyethylene-amino)-butane-4-sulfonate sodium salt in 2 g diethylene glycol using a speed mixer. A white paste is obtained. This is applied using doctor blade technology onto a first ITO-coated PET film. A second ITO-coated PET film acting as a counter electrode is adhesively bonded to the first electrode as a backing electrode by a double-sided adhesive tape frame. When a direct-current voltage of 3V is applied for one minute, a deep blue color impression is created. For example, the following laboratory values (the initial values in parentheses) are measured after 12 days (GretagMcBeth Eye One): L=28(18), a=4.5 (4), b=−21 (−29).

2.3. 6 g titanium dioxide are dispersed with 0.6 g poly(dodecylene-4,4′-bipyridinium-dibromide) and 0.32 g 1-diethanol-amino)-butane-4-sulfonate sodium salt in 2 g diethylene glycol using a speed mixer. A white paste is obtained. This is applied using doctor blade technology onto a first ITO-coated PET film. A second ITO-coated PET film acting as a counter electrode is adhesively bonded to the first electrode as a backing electrode by a double-sided adhesive tape frame. When a direct-current voltage of 3V is applied for one minute, a deep blue color impression is created. For example, the following laboratory values (the initial values in parentheses) are measured after 12 days (GretagMcBeth Eye One): L=38(20), a=6 (12), b=−22 (−22).

2.4. 6 g titanium dioxide are dispersed with 0.6 g poly(dodecylene-4,4′-bipyridinium-dibromide) and 0.49 g piperazine-N,n′-dibutane-sulfonate sodium salt in 2 g diethylene glycol using a speed mixer. A white paste is obtained. This is applied using doctor blade technology onto a first ITO-coated PET film. A second ITO-coated PET film acting as a counter electrode is adhesively bonded to the first electrode as a backing electrode by a double-sided adhesive tape frame. When a direct-current voltage of 3V is applied for one minute, a deep blue color impression is created. For example, the following laboratory values (the initial values in parentheses) are measured after 12 days (GretagMcBeth Eye One): L=31(20), a=2.5 (4), b=−29 (−20).

An electrochromic formulation which, having once been switched into an activated state, remains in that state when current is no longer applied. The formulation relates for example to the production of state indicators, the activated state of which is maintained for as long as possible without an electric current. The organically based electrochromic formulations are characterized in that one or more arbitrary cathodically (coloring) switchable electrochromic color systems are contained in the formulation, as well as a novel anodically switchable antagonist comprising an amine which dimerizes to a hydrazinium salt by releasing an electron. Titanium dioxide is used as an image background (maximum opacity) and in addition a dispersing agent is also introduced which can also be crosslinked or partly crosslinked.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-7. (canceled)

8. A bistable switchable electrochromic formulation comprising:
a cathodically switchable electrochromic color system;
an anodically switchable antagonist having the following structure I 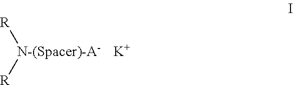
where
“Spacer” stands for an alkene grouping with up to 18 carbon atoms,
R is selected from the group consisting of alkyl residues with 2 to 10 carbon atoms, hydroxyalkyl residues with 2 to 10 carbon atoms, phenyl, p-tolyl, m-tolyl and mesityl residues, residues suitable for forming dimers and polymers and have a free valence, and residues suitable for crosslinking the two R groups, such that the two R groups bind in a bidentate manner to the nitrogen,
A⁻ is an anion, and
K⁺ is a cation;
a white pigment; and
a dispersing agent which can be at least partly crosslinked.

9. The formulation as claimed in claim 8, wherein the cathodically switchable electrochromic color system is a 4,4′-bipyridinium compound or a substituted form thereof.

10. The formulation as claimed in claim 8, wherein the cathodically switchable electrochromic color system is selected from the group consisting of N,N′-disubstituted saline derivatives of bipyridines and N,N′-disubstituted saline derivatives of 2,5-di(pyridine-4-yl)pyrimidine.

11. The formulation as claimed in claim 8, wherein the cathodically switchable electrochromic color system is selected from the group consisting of poly-dodecylene-4,4′-bipyridinium-dibromide and N,N′-diheptyl-2,5-pyrimidinylene-di-4-pyridinium-dibromide.

12. The formulation as claimed in claim 8, wherein the white pigment is titanium dioxide.

13. The formulation as claimed in claim 8, wherein the dispersing agent is a glycol.

14. The formulation as claimed in claim 8, wherein in the structure I, “Spacer” stands for an alkene grouping having from 2 to 6 C atoms.

15. The formulation as claimed in claim 8, wherein in the structure I, A⁻ is an —SO₃⁻, —COO⁻, or —O⁻ anion.

16. The formulation as claimed in claim 8, wherein in the structure I, K⁺ is an alkali ion, an ammonium ion, or a substituted alkyl ammonium ion.

17. The formulation as claimed in claim 8, wherein the anodically switchable antagonist is represented by the following formula:

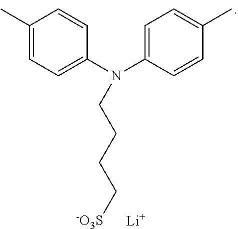

18. The formulation as claimed in claim 8, wherein the anodically switchable antagonist is represented by the following formula:

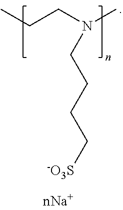

19. The formulation as claimed in claim 8, wherein the anodically switchable antagonist is represented by the following formula:

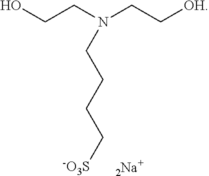

20. The formulation as claimed in claim 8, wherein the anodically switchable antagonist is represented by the following formula:

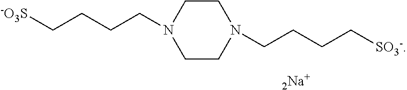

21. A method for producing a bistable switchable electrochromic formulation, comprising:
providing an anodically switchable antagonist having the following structure I 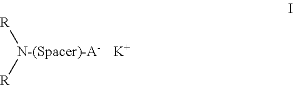
where
“Spacer” stands for an alkene grouping with up to 18 carbon atoms,
R is selected from the group consisting of alkyl residues with 2 to 10 carbon atoms, hydroxyalkyl residues with 2 to 10 carbon atoms, phenyl, p-tolyl, m-tolyl and mesityl residues, residues suitable for forming dimers and polymers and have a free valence, and residues suitable for crosslinking the two R groups, such that the two R groups bind in a bidentate manner to the nitrogen,
A⁻ is an anion, and
K⁺ is a cation;
using a speed mixer to mix the anodically switchable antagonist, a white pigment and a cathodically switchable electrochromic color system in a dispersing agent, such that a paste is produced having a viscosity suitable for doctor blade processing.

22. An organic electrochromic component comprising:
at least first and second electrodes; and
a bistable switchable electrochromic formulation sandwiched between the first and second electrodes, the electrochromic formulation comprising:
a cathodically switchable electrochromic color system;
an anodically switchable antagonist having the following structure I 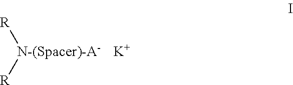
where
“Spacer” stands for an alkene grouping with up to 18 carbon atoms,
R is selected from the group consisting of alkyl residues with 2 to 10 carbon atoms, hydroxyalkyl residues with 2 to 10 carbon atoms, phenyl, p-tolyl, m-tolyl and mesityl residues, residues suitable for forming dimers and polymers and have a free valence, and residues suitable for crosslinking the two R groups, such that the two R groups bind in a bidentate manner to the nitrogen,
A⁻ is an anion, and
K⁺ is a cation;
a white pigment; and
a dispersing agent which can be at least partly crosslinked.
